(19) United States
(12) Patent Application Publication
(10) Pub. No.: US 2026/0150123 A1
(43) Pub. Date: May 28, 2026

(54) Incorporating Historical Interference Data in Auto Channel Selection (ACS)

(71) Applicant: Arista Networks, Inc., Santa Clara, CA (US)

(72) Inventors: Agrim SRIVASTAVA, Pune (IN); Parag MITTAL, Pune (IN); Nisarg PARMAR, Pune (IN)

(21) Appl. No.: 18/956,594

(22) Filed: Nov. 22, 2024

(51) Int. Cl. H04W 72/541; H04W 72/0453

(52) U.S. Cl. CPC H04W 72/541; H04W 72/0453

(57) ABSTRACT

Techniques for gathering historical interference data during the channel scanning phase of Auto Channel Selection (ACS) and using the historical interference data for channel selection. With these techniques, a Wi-Fi access point (AP) that implements ACS can more accurately select the optimal channel for a frequency band, resulting in an improved experience for Wi-Fi clients and other devices that communicate with the AP via that band.

### BACKGROUND

Auto Channel Selection (ACS) is a feature implemented in Wi-Fi access points (APs) that is designed to automatically select the “optimal” channel for a frequency band, or in other words the channel that is subject to the least interference and thus can provide the best Wi-Fi performance. ACS typically runs at a predefined interval, such as every 12 or 24 hours, and during each interval ACS collects information regarding the levels of interference present on the frequency band's channels (referred to as channel scanning) and uses the collected interference information to select the optimal channel (referred to as channel selection).

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example Wi-Fi AP in accordance with certain embodiments of the present disclosure.

FIG. 2 depicts a modified version of the Wi-Fi AP of FIG. 1 in accordance with certain embodiments of the present disclosure.

FIGS. 3A, 3B, and 3C depict a workflow for implementing the channel scanning phase of ACS in accordance with certain embodiments of the present disclosure.

FIG. 4 depicts a workflow for implementing the channel selection phase of ACS in accordance with certain embodiments of the present disclosure.

FIG. 5 depicts another workflow for implementing the channel scanning phase of ACS in accordance with certain embodiments of the present disclosure.

FIG. 6 depicts another workflow for implementing the channel selection phase of ACS in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for gathering historical interference data during the channel scanning phase of ACS and using the historical interference data for channel selection. With these techniques, a Wi-Fi AP that implements ACS can more accurately select the optimal channel for a frequency band, resulting in an improved experience for Wi-Fi clients and other devices that communicate with the AP via that band.

### 1. Example Wi-Fi AP

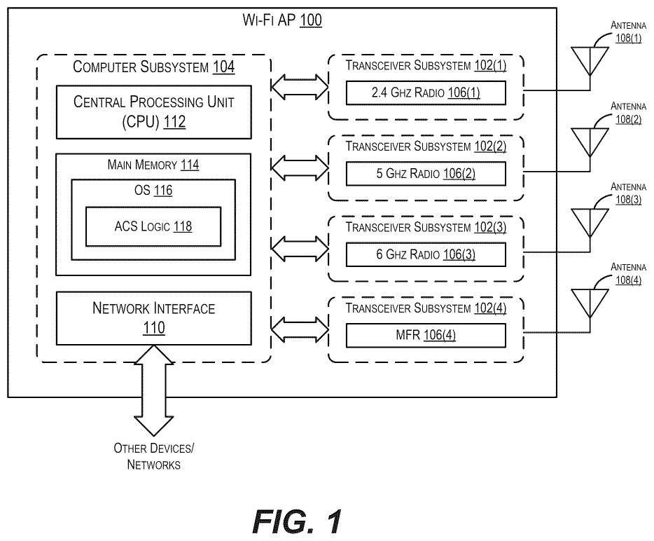

FIG. 1 is a simplified block diagram of a Wi-Fi AP 100 in which the techniques of the present disclosure may be implemented. As shown, Wi-Fi AP 100 comprises a set of transceiver subsystems 102(1)-(4) that are communicatively coupled with a computer subsystem 104.

Each transceiver subsystem 102 includes, among other things, a radio 106 that transmits and receives radio frequency (RF) signals via a corresponding antenna 108. In transceiver subsystems 102(1) through 102(3), each radio 106(1)/106(2)/106(3) supports a particular Wi-Fi frequency band and is configured to operate on one or more channels (i.e., frequency ranges) in that band, thereby enabling Wi-Fi communication between Wi-Fi AP 100 and other Wi-Fi devices (e.g., clients and other APs). For example, transceiver subsystem 102(1) has a 2.4 GHz radio 106(1) that is configured to operate on one or more channels in the 2.4 GHz frequency band (thereby enabling communication with 2.4 GHz clients/APs), transceiver subsystem 102(2) has a 5 GHz radio 106(2) that is configured to operate on one or more channels in the 5 GHz frequency band (thereby enabling communication with 5 GHz clients/APs), and transceiver subsystem 102(3) has a 6 GHz radio 106(3) that is configured to operate on one or more channels in the 6 GHz frequency band (thereby enabling communication with 6 GHz clients/APs).

In contrast to transceiver subsystems 102(1)-(3), transceiver subsystem 102(4) has a special type of radio 106(4), known as a multi-function radio (MFR), that is configured to carry out various functions beyond providing standard Wi-Fi connectivity. Examples of such functions include wireless intrusion detection, network health monitoring, and channel scanning (explained below).

Computer subsystem 104 of Wi-Fi AP 100 includes, among other things, a network interface 110, a central processing unit (CPU) 112, and a main memory (e.g., random-access memory or RAM) 114. Network interface 110 connects Wi-Fi AP 100 to a wired network, typically through one or more Ethernet ports. CPU 112 is a general purpose processor that is responsible for managing the configuration and operation of Wi-Fi AP 100 and its constituent components, including transceiver subsystems 102(1)-(4)). CPU 112 performs these tasks under the direction of an operating system 116 that runs on CPU 112 from main memory 114.

One task carried out by CPU 112 (via an ACS logic module 118 in OS 116) is Auto Channel Selection (ACS). As mentioned previously, ACS is a feature that enables Wi-Fi APs to automatically select the optimal or best channel to operate on for a given frequency band. For example, with respect to 2.4 GHz radio 106(1) of transceiver subsystem 102(1), ACS logic module 118 can automatically select the optimal/best channel in the 2.4 GHz band for use by radio 106(1). Similarly, with respect to 5 GHz radio 106(2) of transceiver subsystem 102(2) and 6 GHz radio 106(3) of transceiver subsystem 102(3), ACS logic module 118 can automatically select the optimal/best channels in the 5 and 6 GHz bands for use by radios 106(2) and 106(3) respectively. ACS is usually run at a predefined interval, referred to as the ACS interval, and comprises two main phases: channel scanning and channel selection. ACS may also run at one or more scheduled times of day, in which case the time period(s) between the scheduled time(s) constitute the ACS interval.

The channel scanning phase is carried out continuously over the course of the ACS interval and generally involves (1) collecting interference readings indicating the levels of various types of interference present on each channel in a round robin fashion, and (2) computing/tracking metrics based on the collected interference readings. Each interference reading is typically expressed as a percentage from 0% to 100%.

The amount of time needed for Wi-Fi AP 100 to scan all channels in the frequency band (and thus, the amount of time between successive interference readings for a given channel) is referred to as the scan cycle. In Wi-Fi APs with a MFR (like AP 100 of FIG. 1), channel scanning is performed using the MFR and the scan cycle is relatively short (e.g., approximately 10 seconds for the 6 GHz band). In Wi-Fi APs without a MFR, channel scanning is performed using the AP's operating radios (or in other words, the radios used for standard Wi-Fi connectivity, such as radios 106(1)-(3) shown in FIG. 1). Because these operating radios spend most of their time servicing connected Wi-Fi clients/APs, the scan cycle using an operating radio is much longer than the scan cycle using a MFR (e.g., approximately 15 minutes for the 6 GHz band).

The channel selection phase is carried out at the end of the ACS interval and generally involves (1) determining a list of candidate channels based on the interference metrics computed and tracked during the channel scanning phase, and (2) selecting a final (i.e., optimal) operating channel for the frequency band from the candidate channel list. Once the optimal channel is selected, the Wi-Fi AP switches over to using that channel for the next ACS interval, if the selected channel is different from the current operating channel.

With existing ACS implementations, two types of metrics are computed and tracked during the channel scanning phase on a given channel C for “non-Wi-Fi” interference (i.e., interference originating from sources that do not use the Wi-Fi protocol, such as microwaves, Bluetooth devices, and so on): a moving average of the non-Wi-Fi interference readings for C and the maximum non-Wi-Fi interference reading for C. However, both of these metrics are problematic. For example, the maximum reading captures the highest instantaneous level of non-Wi-Fi interference detected during the ACS interval but lacks historical context and is susceptible to false positives. Further, the moving average tends to skew towards the readings collected at the end of the ACS interval (i.e., just before channel selection is performed), which prevents it from adequately considering the full range of readings collected over the entire ACS interval.

### 2. Solution Overview

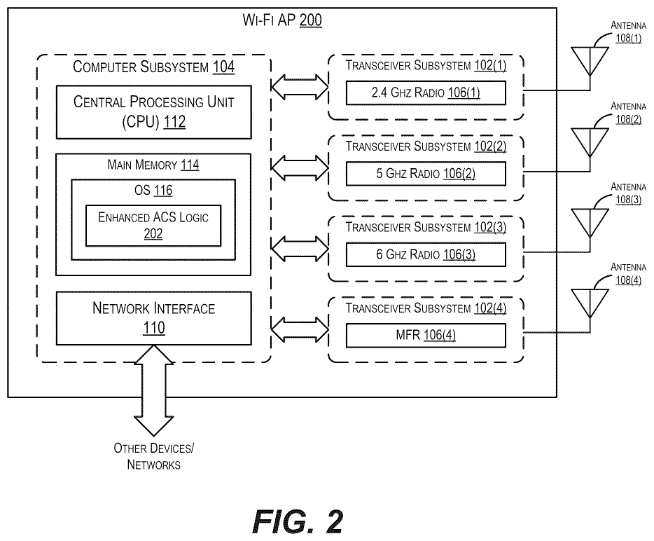

To address the foregoing problems, FIG. 2 depicts a modified version 200 of Wi-Fi AP 100 of FIG. 1 that includes an enhanced ACS logic module 202 (in lieu of conventional ACS logic module 118). In FIG. 2, enhanced ACS logic module 202 is shown as being part of OS 116 and thus is implemented in software (i.e., program code) that is executable by CPU 112 of Wi-Fi AP 200. In alternative embodiments, some or all of the functionality of enhanced ACS logic module 202 may be implemented partially or entirely in the hardware of Wi-Fi AP 100, or in the software and/or hardware of a remote device/server.

At a high level, enhanced ACS logic module 202 supports two novel approaches for implementing the ACS channel scanning phase that more effectively capture historical non-Wi-Fi interference data. With either of these two approaches, Wi-Fi AP 200 can advantageously avoid the limitations of existing ACS implementations (i.e., susceptibility to false positives and skewing of metrics towards the most recent readings), thereby allowing for more effective channel selection, particularly in dense RF environments with many sources of non-Wi-Fi interference (e.g., office buildings, school campuses, etc.).

The first approach, hereinafter referred to as the “sliding window approach,” is intended for use in Wi-Fi APs with MFRs (like Wi-Fi AP 200) and generally involves monitoring a sliding window of N consecutive non-Wi-Fi interference readings per channel. If a certain number of those N readings for a channel exceeds a predefined interference threshold, the channel is considered to be in a “non-Wi-Fi-interference detected” state and remains in this state until the number of threshold-exceeding readings in the window falls back below the threshold. Upon exiting the non-Wi-Fi-interference detected state, enhanced ACS logic module 202 computes the total time Wi-Fi AP 200 was in that state (referred to as downtime) and uses this downtime value to update two metrics: the maximum downtime experienced by the channel during the ACS interval and the total cumulative downtime for the channel during the ACS interval. Enhanced ACS logic module 202 thereafter uses the maximum downtime and cumulative downtime metrics during the channel selection phase to construct the candidate channel list.

The second approach, hereinafter referred to as the “bucket approach,” is intended for use in Wi-Fi APs without MFRs and generally involves organizing the collected non-Wi-Fi interference readings for each channel into buckets and inferring an overall non-Wi-Fi interference level for the channel based on the bucket with the most readings. Enhanced ACS logic module 202 then uses these overall interference levels during the channel selection phase to construct the candidate channel list. This approach is generally preferable over the sliding window approach in Wi-Fi APs without MFRs because such APs have a long scan cycle and the sliding window approach relies on a relatively short scan cycle to produce accurate results.

The remaining sections of the present disclosure provide additional details regarding the implementation of the sliding window and bucket approaches according to certain embodiments. It should be appreciated that FIGS. 1 and 2 and the foregoing high-level solution description are illustrative and not intended to be limiting. For example, although FIG. 2 depicts Wi-Fi AP 200 as including a MFR, in alternative embodiments AP 200 may not have a MFR. In these embodiments, enhanced ACS logic module 202 can employ the bucket approach for the channel selection phase.

Further, although the present disclosure focuses on the computation and tracking of metrics pertaining to non-Wi-Fi interference, the same or similar approaches can also be applied to compute and track metrics pertaining to other types of RF interference (e.g., Wi-Fi interference, RADAR interference, etc.) for ACS purposes.

### 3. Sliding Window Approach

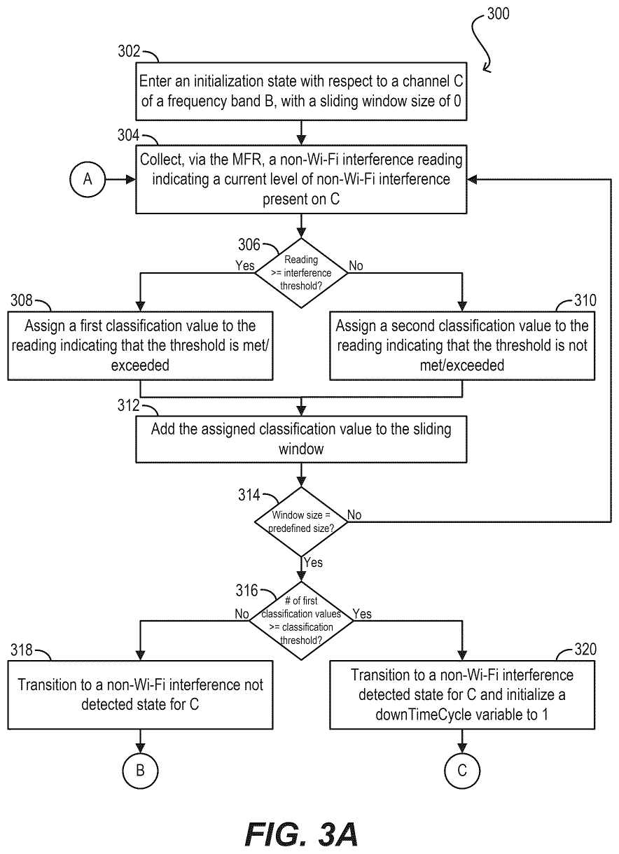

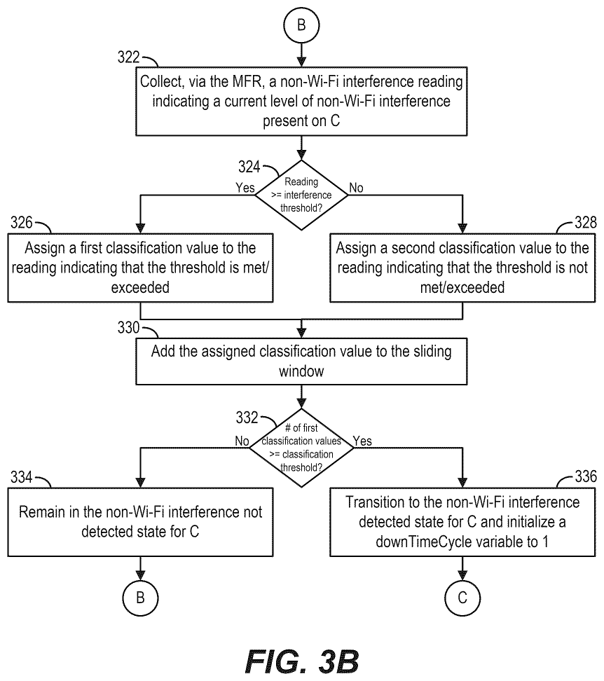

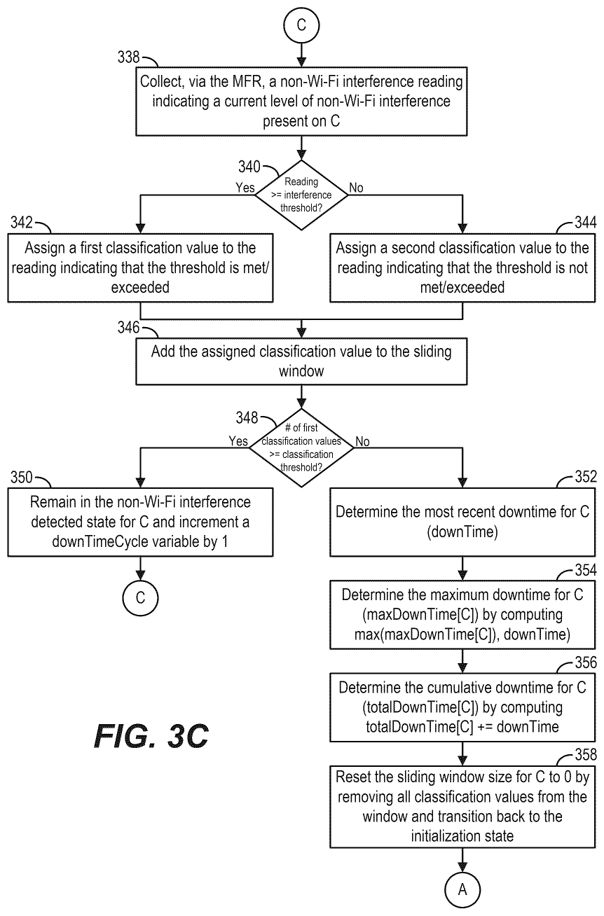

FIGS. 3A, 3B, and 3C depict a workflow 300 that can be executed by enhanced ACS logic module 202 of FIG. 2 for implementing the channel scanning phase of an ACS interval for a channel C of a frequency band B using the sliding window approach according to certain embodiments. In particular, FIG. 3A depicts a portion of workflow 300 that can be executed by enhanced ACS logic module 202 while in an initialization state with respect to channel C, FIG. 3B depicts a portion of workflow 300 that can be executed by enhanced ACS logic module 202 while in a “non-Wi-Fi interference not detected” state with respect to channel C, and FIG. 3C depicts a portion of workflow 300 that can be executed by enhanced ACS logic module 202 while in a “non-Wi-Fi interference detected” state with respect to channel C. Enhanced ACS logic module 202 can execute an instance of workflow 300 for every channel of frequency band B that is a candidate for ACS. It is assumed that all variables described in workflow 300 are set/reset to initial or null values prior to execution of the workflow.

Starting with step 302 of FIG. 3A, enhanced ACS logic module 202 can enter the initialization state with respect to channel C, with a sliding window size of 0 (which means that the sliding window currently contains zero non-Wi-Fi interference readings for C). Enhanced ACS logic module 202 can then collect, via MFR 106(4), a non-Wi-Fi interference reading for channel C that indicates the current level of non-Wi-Fi interference present on C (step 304) and can check whether the collected reading meets or exceeds a predefined interference threshold, such as 40% (step 306).

If the answer is yes, enhanced ACS logic module 202 can assign a first classification value to the reading indicating that the interference threshold is met/exceeded (e.g., a classification value of 1) (step 308). Alternatively, if the answer is no, enhanced ACS logic module 202 can assign a second classification value to the reading indicating that the interference threshold is not met/exceeded (e.g., a classification value of 0) (step 310). Enhanced ACS logic module 202 can subsequently add the assigned classification value to the sliding window (step 312) and check whether the size of the sliding window (or in other words, the number of classification values in the sliding window) has now reached a predefined window size (e.g., a size of 8) (step 314).

If the answer at step 314 is no (i.e., the sliding window size is below the predefined window size), enhanced ACS logic module 202 can return to step 304. However, if the answer at step 314 is yes (i.e., the sliding window size has reached the predefined window size), enhanced ACS logic module 202 can further check whether the number of first classification values in the sliding window (or in other words, the number of classification values indicating the predefined interference threshold was met/exceeded) meets or exceeds a predefined classification threshold (step 316).

If the answer at step 316 is no, enhanced ACS logic module 202 can transition from the initialization state to the non-Wi-Fi interference not detected state for channel C (step 318) and proceed to FIG. 3B. However, if the answer at step 316 is yes, enhanced ACS logic module 202 can transition from the initialization state to the non-Wi-Fi interference detected state for channel C, initialize a “downTimeCycle” variable to 1 (step 320), and proceed to FIG. 3C.

Turning now to FIG. 3B (which represents the operation of enhanced ACS logic module 202 while in the non-Wi-Fi interference not detected state), module 202 can collect a non-Wi-Fi interference reading for channel C via MFR 106(4) (step 322) and check whether the collected reading meets or exceeds the predefined interference threshold (step 324). If the answer is yes, enhanced ACS logic module 202 can assign the first classification value to the reading (step 326) and if the answer is no, module 202 can assign the second classification value to the reading (step 328). Enhanced ACS logic module 202 can then add the assigned classification value to the sliding window (step 330). Note that the oldest classification value will be dropped from the sliding window at step 330 in order to maintain a window size equal to the predefined window size.

At step 332, enhanced ACS logic module 202 can check whether the number of first classification values in the sliding window now meets or exceeds the predefined classification threshold. If the answer is no, enhanced ACS logic module 202 can remain in the non-Wi-Fi interference not detected state for channel C (step 334) and return to step 322. However, if the answer is yes, enhanced ACS logic module 202 can transition from the non-Wi-Fi interference not detected state to the non-Wi-Fi interference detected state for channel C, initialize the downTimeCycle variable to 1 (step 336), and proceed to FIG. 3C.

Turning now to FIG. 3C (which represents the operation of enhanced ACS logic module 202 while in the non-Wi-Fi interference detected state), module 202 can collect a non-Wi-Fi interference reading for channel C via MFR 106(4) (step 338) and check whether the collected reading meets or exceeds the predefined interference threshold (step 340). If the answer is yes, enhanced ACS logic module 202 can assign the first classification value to the reading (step 342) and if the answer is no, module 202 can assign the second classification value to the reading (step 344). Enhanced ACS logic module 202 can then add the assigned classification value to the sliding window (step 346). Note that the oldest classification value will be dropped from the sliding window at step 346 in order to maintain a window size equal to the predefined window size.

At step 348, enhanced ACS logic module 202 can check whether the number of first classification values in the sliding window meets or exceeds the predefined classification threshold. If the answer is yes, enhanced ACS logic module 202 can remain in the non-Wi-Fi interference detected state for channel C, increment the downTimeCycle variable by 1 (step 350), and return to step 338.

However, if the answer at step 348 is no, enhanced ACS logic module 202 can determine the most recent downtime for channel C (denoted as “downTime”) (step 352). In one set of embodiments, ACS logic module 202 can determine the most recent downtime by multiplying the downTimeCycle variable by the scan cycle time of MRF 106(4). In another set of embodiments, ACS logic module 202 can determine the most recent downtime by computing the difference between the current time and the time at which module 202 entered the non-Wi-Fi interference detected state. In addition, enhanced ACS logic module 202 can determine the maximum downtime observed so far for channel C (denoted as “maxDownTime[C]”) by computing the maximum of maxDownTime[C] and downTime (i.e., max(maxDownTime[C], downtime)) (step 354), and can determine the cumulative downtime observed so far for channel C (denoted as “totalDownTime[C]”) by incrementing totalDownTime[C] by downTime (i.e., totalDownTime[C]+=downTime) (step 356).

Finally, enhanced ACS logic module 202 can reset the sliding window size back to 0 by removing all classification values from the window (step 358) and can transition back to the initialization state for channel C by returning to step 304 of FIG. 3A. Although not explicitly shown, enhanced ACS logic module 202 will continue to cycle through the initialization, non-Wi-Fi interference not detected, and non-Wi-Fi interference detected states for channel C as described above until the ACS interval ends. At the conclusion of the ACS interval, maxDownTime[C] will hold the maximum downtime observed for channel C during the interval and totalDownTime[C] will hold the cumulative (i.e., total) downtime observed for channel C during the interval.

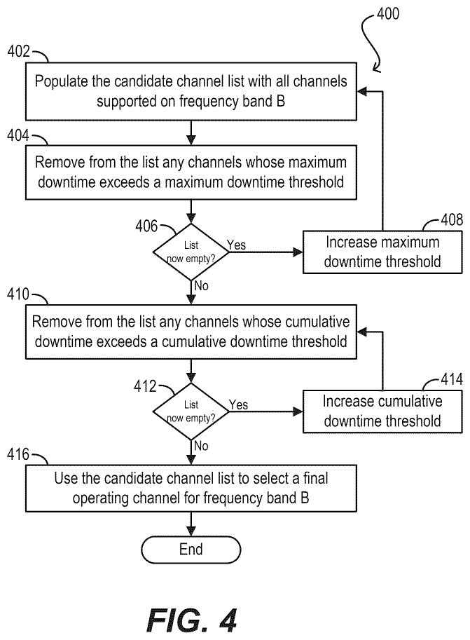

FIG. 4 depicts a workflow 400 that can be executed by enhanced ACS logic module 202 for using the per-channel maximum downtime/cumulative downtime metrics determined via workflow 300 with respect to frequency band B in order to construct a candidate channel list for B during the channel selection phase of the ACS interval (which occurs at the end of the interval) according to certain embodiments.

Starting with step 402, enhanced ACS logic module 202 can populate the candidate channel list with all of the channels supported on frequency band B.

At step 404, enhanced ACS logic module 202 can remove from the candidate channel list any channels whose maximum downtime (as determined during the channel scanning phase) exceeds a maximum downtime threshold. Enhanced ACS logic module 202 can then check whether the candidate channel list is now empty (step 406).

If the answer is yes, enhanced ACS logic module 202 can increase the maximum downtime threshold by some amount (e.g., 10%) (step 408) and return to step 402. However, if the answer at step 406 is no, enhanced ACS logic module 202 can remove from the candidate channel list any channels whose cumulative downtime (as determined during the channel scanning phase) exceeds a cumulative downtime threshold (step 410) and once again check whether the list is now empty (step 412).

If the answer at step 412 is yes, enhanced ACS logic module 202 can increase the cumulative downtime threshold by some amount (step 414), repopulate the candidate channel list as it was immediately prior to step 410 (not shown), and return to step 410. However, if the answer at step 412 is no, enhanced ACS logic module 202 can use the candidate channel list to select a final operating channel for frequency band B (step 416) and the workflow can end.

### 4. Bucket Approach

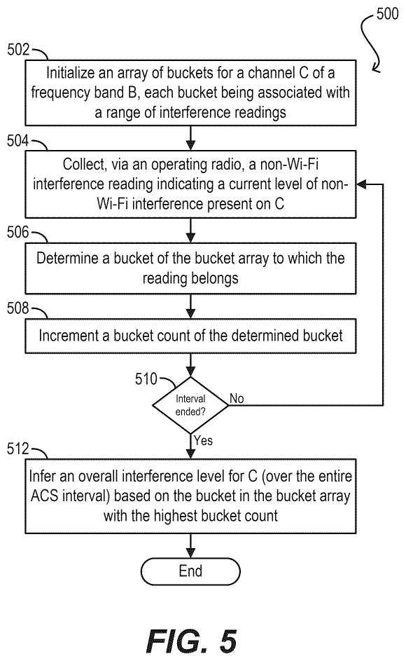

FIG. 5 depicts a workflow 500 that can be executed by enhanced ACS logic module 202 of FIG. 2 for implementing the channel scanning phase of an ACS interval for a channel C of a frequency band B using the bucket approach according to certain embodiments. Enhanced ACS logic module 202 can execute an instance of workflow 500 for every channel of frequency band B that is a candidate for ACS.

Starting with step 502, enhanced ACS logic module 202 can initialize an array of buckets for channel C, where each bucket in the bucket array is associated with (or in other words, keyed by) a range of non-Wi-Fi interference readings and is configured to hold a bucket count. For example, in one set of embodiments the bucket array can comprise ten buckets with equally-spaced ranges where the first bucket is associated with the interference reading range [0-10%], the second bucket is associated with the interference reading range [11-20%], and so on, such that the last (tenth) bucket is associated with the interference reading range [91-100%].

At step 504, enhanced ACS logic module 202 can collect, via an operating radio of Wi-Fi AP 200 configured to operate on frequency band B (e.g., one of radios 106(1), 106(2), or 106(3)), a non-Wi-Fi interference reading for channel C that indicates the current level of non-Wi-Fi interference present on C. Enhanced ACS logic module 202 can then determine a bucket in the bucket array to which the collected reading belongs (step 506) and can increment the bucket count for the determined bucket (step 508). For example, if the collected reading is 26% and the bucket array is divided into ten buckets as described above, enhanced ACS logic module 202 will determine that the reading belongs to the third bucket (which is associated with the interference range [21-30%]) and increment the bucket count of the third bucket.

At step 510, enhanced ACS logic module 202 can check whether the ACS interval has ended. If the answer is no, enhanced ACS logic module 202 can return to step 504. However, if the answer is yes, enhanced ACS logic module 202 can infer an overall non-Wi-Fi interference level for channel C over the ACS interval based on the bucket in the bucket array with the highest bucket count (step 512) and the workflow can end. For instance, if the bucket with the highest bucket count at the end of the ACS interval is the third bucket in the example above (i.e., the bucket associated with the interference range [21-30%]), enhanced ACS logic module 202 can infer an overall non-Wi-Fi interference level for channel C that is derived from the range [21-30%] (e.g., the middle of the range (25%), the bottom of the range (21%), or the top of the range (30%)).

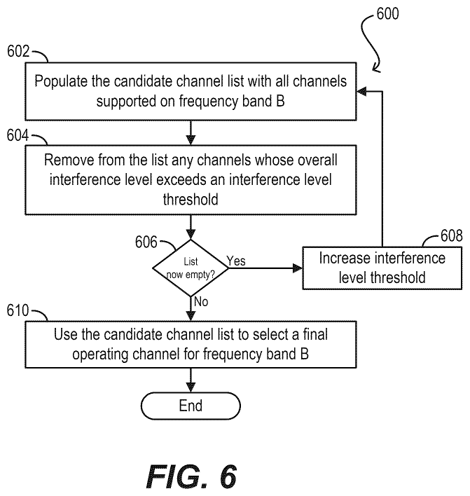

FIG. 6 depicts a workflow 600 that can be executed by enhanced ACS logic module 202 for using the per-channel overall interference levels determined via workflow 500 with respect to frequency band B in order to construct a candidate channel list for B during the channel selection phase of the ACS interval according to certain embodiments.

Starting with step 602, enhanced ACS logic module 202 can populate the candidate channel list with all of the channels supported on frequency band B.

At step 604, enhanced ACS logic module 202 can remove from the candidate channel list any channels whose overall interference level (as determined during the channel scanning phase) exceeds an interference level threshold. Enhanced ACS logic module 202 can then check whether the candidate channel list is now empty (step 606).

If the answer is yes, enhanced ACS logic module 202 can increase the interference level threshold by some amount (e.g., 20%) (step 608) and return to step 602. However, if the answer at step 606 is no, enhanced ACS logic module 202 can use the candidate channel list to select a final operating channel for frequency band B (step 610) and the workflow can end.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a Wi-Fi access point (AP) during a channel scanning phase of an Auto Channel Selection (ACS) interval, the method comprising:
entering an initialization state with respect to a channel of a frequency band;
collecting an interference reading indicating a current level of interference present on the channel;
in response to the collecting:
determining whether the interference reading meets or exceeds an interference threshold;
upon determining that the interference reading meets or exceeds the interference threshold, adding a first classification value to a sliding window of classification values for the channel; and
upon determining that the interference reading does not meet or exceed the interference threshold, adding a second classification value to the sliding window of classification values for the channel; and
in response to adding the first classification value or the second classification value to the sliding window:
determining whether the sliding window has reached a predetermined window size;
upon determining that the sliding window has not reached the predetermined window size, transitioning to an interference not detected state; and
upon determining that the sliding window has reached the predetermined window size, transitioning to an interference detected state and initializing a downtime cycle variable to 1.

2. The method of claim 1 wherein the interference reading indicates a current level of non-Wi-Fi interference present on the channel.

3. The method of claim 1 wherein the interference reading is collected using a multi-function radio (MFR) of the Wi-Fi AP.

4. The method of claim 1 further comprising, while in the interference not detected state:
collecting another interference reading indicating a current level of interference present on the channel; and
in response to collecting said another interference reading:
determining whether said another interference reading meets or exceeds the interference threshold;
upon determining that said another interference reading meets or exceeds the interference threshold, adding the first classification value to the sliding window; and
upon determining that said another interference reading does not meet or exceed the interference threshold, adding the second classification value to the sliding window.

5. The method of claim 4 wherein adding the first classification value or the second classification value to the sliding window includes removing an oldest classification value from the sliding window.

6. The method of claim 4 further comprising, in response to adding the first classification value or the second classification value to the sliding window:
determining whether a number of first classification values in the sliding window meets or exceeds a classification threshold;
upon determining that the number of first classification values does not meet or exceed the classification threshold, remaining in the interference not detected state; and
upon determining that the number of first classification values meets or exceeds the classification threshold, transitioning to the interference detected state and initializing the downtime cycle variable to 1.

7. The method of claim 1 further comprising, while in the interference detected state:
collecting another interference reading indicating a current level of interference present on the channel; and
in response to collecting said another interference reading:
determining whether said another interference reading meets or exceeds the interference threshold;
upon determining that said another interference reading meets or exceeds the interference threshold, adding the first classification value to the sliding window; and
upon determining that said another interference reading does not meet or exceed the interference threshold, adding the second classification value to the sliding window.

8. The method of claim 7 further comprising, in response to adding the first classification value or the second classification value to the sliding window:
determining whether a number of first classification values in the sliding window meets or exceeds a classification threshold;
upon determining that the number of first classification values meets or exceeds the classification threshold, remaining in the interference detected state and incrementing the downtime cycle variable by 1; and
upon determining that the number of first classification values does not meet or exceed the classification threshold:
determining a most recent downtime for the channel;
determining a maximum downtime for the channel by computing the maximum of a current value of the maximum downtime and the most recent downtime;
determining a cumulative downtime for the channel by incrementing a current value of the cumulative downtime by the most recent downtime;
removing all classification values from the sliding window; and
transitioning back to the initialization state.

9. The method of claim 8 further comprising, during a channel selection phase of the ACS interval:
populating a candidate channel list with all channels supported on the frequency band;
removing from the candidate channel list any channel whose maximum downtime exceeds a maximum downtime threshold; and
upon determining that the candidate channel list has become empty in response to removing any channel whose maximum downtime exceeds the maximum downtime threshold, increasing the maximum downtime threshold and repeating the populating and the removing.

10. The method of claim 9 further comprising, upon determining that the candidate channel list has not become empty in response to removing any channel whose maximum downtime exceeds the maximum downtime threshold:
removing from the candidate channel list any channel whose cumulative downtime exceeds a cumulative downtime threshold; and
upon determining that the candidate channel list has become empty in response to removing any channel whose cumulative downtime exceeds the cumulative downtime threshold:
increasing the cumulative downtime threshold;
repopulating the candidate channel list to a state immediately prior to the removing; and
repeating the removing.

11. The method of claim 10 further comprising, upon determining that the candidate channel list has not become empty in response to removing any channel whose cumulative downtime exceeds the cumulative downtime threshold:
using the candidate channel list to select an optimal channel for the frequency band.

12. A Wi-Fi access point (AP) comprising:
a processor; and
a memory having stored thereon program code that, when executed by the processor, causes the processor to, during a channel scanning phase of an Auto Channel Selection (ACS) interval:
enter an initialization state with respect to a channel of a frequency band;
collect an interference reading indicating a current level of interference present on the channel;
in response to the collecting:
determine whether the interference reading meets or exceeds an interference threshold;
upon determining that the interference reading meets or exceeds the interference threshold, add a first classification value to a sliding window of classification values for the channel; and
upon determining that the interference reading does not meet or exceed the interference threshold, add a second classification value to the sliding window of classification values for the channel; and
in response to adding the first classification value or the second classification value to the sliding window:
determine whether the sliding window has reached a predetermined window size;
upon determining that the sliding window has not reached the predetermined window size, transition to an interference not detected state; and
upon determining that the sliding window has reached the predetermined window size, transition to an interference detected state and initialize a downtime cycle variable to 1.

13. The Wi-Fi AP of claim 12 wherein the Wi-Fi AP further comprises a multi-function radio (MFR) and wherein the interference reading is collected using the MFR.

14. The Wi-Fi AP of claim 12 wherein the program code further causes the processor to, while in the interference detected state:
collect another interference reading indicating a current level of interference present on the channel; and
in response to collecting said another interference reading:
determine whether said another interference reading meets or exceeds the interference threshold;
upon determining that said another interference reading meets or exceeds the interference threshold, add the first classification value to the sliding window; and
upon determining that said another interference reading does not meet or exceed the interference threshold, add the second classification value to the sliding window.

15. The Wi-Fi AP of claim 14 wherein the program code further causes the processor to, in response to adding the first classification value or the second classification value to the sliding window:
determine whether a number of first classification values in the sliding window meets or exceeds a classification threshold;
upon determining that the number of first classification values meets or exceeds the classification threshold, remain in the interference detected state and increment the downtime cycle variable by 1; and
upon determining that the number of first classification values does not meet or exceed the classification threshold:
determine a most recent downtime for the channel;
determine a maximum downtime for the channel by computing the maximum of a current value of the maximum downtime and the most recent downtime;
determine a cumulative downtime for the channel by incrementing a current value of the cumulative downtime by the most recent downtime;
remove all classification values from the sliding window; and
transition back to the initialization state.

16. The Wi-Fi AP of claim 15 wherein the program code further causes the processor to, during a channel selection phase of the ACS interval:
populate a candidate channel list with all channels supported on the frequency band;
remove from the candidate channel list any channel whose maximum downtime exceeds a maximum downtime threshold;
remove from the candidate list any channel whose cumulative downtime meets or exceeds a cumulative downtime threshold; and
use the candidate channel list to select an optimal channel for the frequency band.

17. A method performed by a Wi-Fi access point (AP) during a channel scanning phase of an Auto Channel Selection (ACS) interval, the method comprising:
monitoring a sliding window of N consecutive interference readings for a channel of a frequency band;
determining a number of the N interference readings that meet or exceed a first threshold; and
upon determining that the number meets or exceeds a second threshold:
entering an interference detected state;
initializing a downtime cycle variable to 1; and
continuing to monitor the sliding window.

18. The method of claim 17 wherein continuing to monitor the sliding window comprises:
collecting and adding a new interference reading for the channel to the sliding window;
removing an oldest interference reading from the sliding window;
determining a new number of the N interference readings that meet or exceed the first threshold; and
upon determining that the new number meets or exceeds the second threshold, incrementing the downtime cycle variable and remaining in the interference detected state.

19. The method of claim 18 further comprising, upon determining that the new number does not meet or exceed the second threshold:
computing a downtime for the channel;
computing a maximum downtime for the channel by taking a maximum of the downtime and the maximum downtime; and
computing a cumulative downtime for the channel by increasing the cumulative downtime by the downtime.

20. The method of claim 19 further comprising:
using the maximum downtime and the cumulative downtime to construct a candidate channel list during a channel selection phase of the ACS interval.
